(19) United States
(12) Patent Application Publication
(10) Pub. No.: US 2008/0280248 A1
(43) Pub. Date: Nov. 13, 2008

(54) Dental Electrode Assembly

(75) Inventors: Nigel Berry Pitts, Dundee (GB); Christopher Longbottom, Dundee (GB); Przemyslaw Los, Dundee (GB)

Correspondence Address: SUGHRUE MION, PLLC, 2100 PENNSYLVANIA AVENUE, N.W., SUITE 800, WASHINGTON, DC, 20037, US

(73) Assignee: IDMOS PLC, Dundee (GB)

(21) Appl. No.: 11/575,626

(22) PCT Filed: Sep. 30, 2005
(86) PCT No.: PCT/GB05/03775

§ 371 Date: Nov. 15, 2007

(30) Foreign Application Priority Data
Oct. 1, 2004 (GB) 0421885.5
Apr. 26, 2005 (GB) 0508469.4

(51) Int. Cl. A61C 3/00

(52) U.S. Cl. 433/32

(57) ABSTRACT

There is described an electrode assembly for passing electrical current through at least part of a tooth, the assembly comprising: an electrode holder; and a plurality of resilient projecting elements coupled to the holder, each element comprising one or more electrodes, the assembly being arranged in use such that when the assembly is positioned adjacent a tooth, the electrodes contact respective parts of at least one surface of the tooth. The assembly is preferably for use in A.C. impedance spectroscopy for caries detection and monitoring.

The present invention relates to an electrode assembly for passing electrical current through at least part of a tooth.

There is increasing interest in developing techniques for providing an accurate determination of the structure of teeth in both animals and humans. It is well known that the tooth structure, particularly in terms of the hard outer enamel of the tooth, can be affected by wear, by localised chemistry on the tooth surface, and other factors. Such changes in the structure are important in providing diagnosis of dental and medical conditions, and for general research purposes.

One of the techniques under development is that of using electrical impedance to determine the tooth structure. In this technique, an electrical current is passed through the tooth under study and the electrical response of the circuit so formed is then monitored, this response providing information in the form of voltage, current and their respective phase. This information is then used to determine the structure of the tooth itself.

Taking human teeth as an example, it will be appreciated that there are a number of different types of human teeth (incisors, canine, premolar and molar), and some of the tooth surfaces are more accessible than others when positioned in the mouth. There are three general types of tooth surfaces, these being the free smooth surfaces (facing inwardly and outwardly of the mouth), the occlusal surfaces (biting surfaces), and the approximal surfaces (these being between adjacent teeth) . Where it is desired for the determination of tooth structure to be related to dental problems such as dental caries, it is particularly important to provide structure determinations of the tooth enamel on the occlusal and approximal surfaces since this is where caries is more prevalent. There is therefore a need for apparatus which is capable of producing accurate electrical impedance measurements upon the occlusal and/or approximal surfaces in particular.

To date, the apparatus and electrodes used for performing electrical impedance measurements upon any tooth surface have been rather experimental, for example the contact electrode being formed from a conducting metallic wire which is simply pressed against the surface of the tooth under study.

Since the commercial use of the electrical impedance technique is attracting increased interest, there is a desire to provide novel electrode apparatus which is compact, reliable and provides for easy and rapid operation.

In accordance with a first aspect of the present invention, we provide an electrode assembly for passing electrical current through at least part of a tooth, the assembly comprises:

an electrode holder; and

a plurality of resilient projecting elements coupled to the holder, each element comprising one or more electrodes, the assembly being arranged in use such that when the assembly is positioned adjacent a tooth, the electrodes contact respective parts of at least one surface of the tooth.

The present invention therefore conveniently addresses the problems discussed above. We have realised that, by using a plurality of projecting resilient elements, if these elements are provided with or indeed constitute electrodes, then electrical impedance measurements can be carried out upon tooth surfaces which are difficult to access by other means. Furthermore, the use of a plurality of such electrodes allows for multiple measurements to be taken in multiple locations upon the tooth, and these may advantageously be upon more than one surface of the tooth without need for the electrode assembly to be moved. Whilst in many cases it is desired to make electrical impedance measurements on one or more surfaces of one tooth, in some cases such measurements can be made upon one or more surfaces of a plurality of teeth, such as adjacent teeth, without moving the assembly.

The electrodes can be used in a number of different ways depending upon the structure information required. The electrode assembly may therefore be used with each electrode acting as effectively a contact electrode. In this case, current is provided through each contact electrode, with the circuit being completed by the use of an additional counter electrode which may be positioned at another part of the body of the human or animal in question, or touched against another part of the tooth.

Although in principal a direct current may be used for the measurements, it is expected that the electrode assembly of the invention will be used primarily with alternating current of one or more frequencies.

It is advantageous of course to ensure that reliable electrical contact is provided with the desired area of the tooth. In some cases therefore, a number of the electrodes in different elements may be connected together electrically. This ensures that a measurement may be made, even where only one of the elements is in electrical contact with the tooth.

The elements may therefore be arranged in groups with the elements either connected together electrically to form a single electrode, or not connected, so as to form separate electrodes. The elements may be arranged individually or in groups in any desired pattern such as in an array (the elements or the elements within groups either being electrically connected together or otherwise).

Where the electrodes of different elements are desired not to be connected electrically, then preferably the assembly further comprises one or more electrical insulating resilient elements which are positioned between the elements having electrodes.

Alternatively, or in addition, one or more barriers of insulating material may be provided, projecting from the holder so as to prevent contact between the electrically conductive elements on opposed sides of the barrier. The barriers may take the form of strips or plates of an electrically insulating material such as polyethylene teraphthalate (PET).

It will be appreciated that the degree of resilience of the elements (those with and/or without electrodes) depends upon their geometry and material from which they are made. In particular, the function of the resilience is to provide biasing of the element electrodes against the respective tooth surface when in use and/or deflection so as to allow other electrodes to also contact the tooth surface. Were the elements extremely rigid, then the lack of deflection or biassing would likely only allow some electrodes to come into contact with the tooth.

The primary function of the holder is to provide an anchor point for the elements. However it may also be formed so that it may be gripped by a user so that the electrodes can be correctly located against the tooth surface(s). The holder may therefore comprise two or more separable parts one of which may, for example, act as the anchor point for the elements, allowing it to be disposable. By providing suitable electrical and mechanical connections between these separable parts, the part containing the elements can be changed for other such parts, for example for making measurements on different teeth, or upon children rather than adults. If each part containing the elements has similar connections then these can be used interchangeably with the other part(s) of the holder to which they are connected when in use.

A number of different electrode assembly configurations are envisaged, depending upon the type of tooth under analysis, and the surfaces of the tooth in question. The elements may therefore project from the holder in substantially at least one direction. In the case of a single direction, the electrode assembly may take the appearance of a toothbrush and the elements may in this case be particularly suited for measurements upon the occlusal surfaces of teeth. However, since five surfaces of a tooth are accessible, these being one occlusal, two approximal and two free smooth surfaces, then the elements may be arranged to project in substantially two, three, four or five directions, in this case preferably the projection direction being in the direction of the respective tooth surface in question when the electrode assembly is positioned for use.

Of course elements for measuring combinations of any of these surfaces may be provided.

In most cases, the elements have different lengths with respect to one another, depending upon their intended use. These lengths may vary within elements intended for use upon the same surface, and/or between those for use upon different surfaces. Typically the relative lengths are adapted so as to conform generally with the shape of the surface of the tooth being investigated.

In some cases, more than one electrode is provided upon a particular projecting element. These may be connected together electrically for providing multiple contact positions, or more preferably, these may be arranged to form individual electrodes providing different contact locations for respective measurements. Preferably in the latter case, each electrode is arranged such that the part of the electrode that contacts the tooth is substantially a point contact.

In other examples, the projecting element may itself be formed from an electrically conductive material (for example stainless steel) such that the element itself is an electrode, and electrical contact can be made at any point along its length. The material in this case (forming the elements) may be metallic although the use of conductive polymers is also advantageous for cost and biological inactivity. Such polymers may have a matrix formed from materials such as natural rubbers or synthetic elastomers. The matrix is provided with conductive components formed from carbon or metals.

Whilst in some cases the entire element may be formed from a conductive material, in others it may be formed generally from an insulating material that is coated within an electrically conductive material such that again it may act as an electrode by contact at substantially any point along its length. The coating may be provided by a material which can be easily used for coating and has biological inactivity, such as gold, titanium, copper, stainless-steel, bronze and their respective alloys, or carbon. Multi-layers of such materials could be employed. Some of these materials may be sputtered onto the elements whereas the use of conductive paints provides a further alternative. The material that is to be coated, and therefore forming most of the element, may be an insulating material such as various plastics, for example nylon or polyesters such as polybutylene terephthalate or polyethylene terephthalate.

Each of the examples later described herein can be constructed using electrically conductive elements of the various types mentioned above, such as by using solid stainless steel wires as the elements.

Depending upon the configuration of the electrodes, an electrical connection to each of the elements having the electrodes may be provided using a respective conductive wire or track.

The dimensions of the elements themselves is dependent upon the application and materials used, although typically the length of the elements lies in the range of 0.5 millimetres to 10 millimetres. The typical thickness in cross-section of the elements lies in the range 50 to 500 micrometres.

Preferably for hygiene purposes, the electrode assembly is disposable in the sense that it is a “one use only” device or at least a “one use only for each patient” device, the latter meaning that the assembly may be reused with only the same patient (or animal). Preferably therefore, the assembly further comprises a connector having contacts arranged in electrical communication with the electrodes, the connector being adapted to detachably couple electrically to a corresponding connector of a monitoring system which provides the electrical current for the measurements.

For ease of use by a user, preferably the holder is formed having an elongate handle such that the holder may be grasped in use so as to hold the electrodes in position in contact with the tooth. Typically the holder is formed from an insulating material such as a plastics material, for example polypropylene, polyamide or SAN, and may also include elastomer parts. In some example assemblies, first and second sensor elements project in a mutually opposed direction from a central electrically insulating barrier, such that the first and second sets are insulated from each other, this assembly being arranged such that, when in use, the first and second sets contact respective first and second teeth. Such an assembly may be used therefore upon surfaces such as the approximal surfaces. Each of the sets of elements in this case is preferably formed from electrically conducting bristles. The bristles of each set are preferably connected together electrically to all other elements in their respective set. The barrier itself may take a number of forms, although typically it is a substantially planar plate formed from a suitable plastics material. For each of these sets of elements, a corresponding wire is preferably provided which runs along one side of the barrier in each case, the bristles forming the electrode elements thereby being attached to the wire so that an equal electrical potential is provided for all electrodes within a particular set.

The monitoring system in some examples may comprise a self-contained hand-held unit, particularly in the case where relatively simple measurements are made.

In accordance with a second aspect of the present invention we provide a system for monitoring the structure of a tooth comprising:

an electrode assembly according to the first aspect of the invention; and

a monitoring device adapted in use to pass an electrical current through at least one electrode of the assembly and at least a corresponding part of the tooth, and to monitor the electrical response of the circuit.

The electrode assembly according to the first aspect can therefore be used in association with a number of different monitoring devices which may form part of a larger monitoring system. It is envisaged that, in some cases, the assembly and monitoring device may together form a hand-held unit which a dentist could hold in a single hand and use to determine the electrical response of each tooth in question.

Some examples of electrode assemblies according to the present invention will now be described, with reference to the accompanying drawings in which:

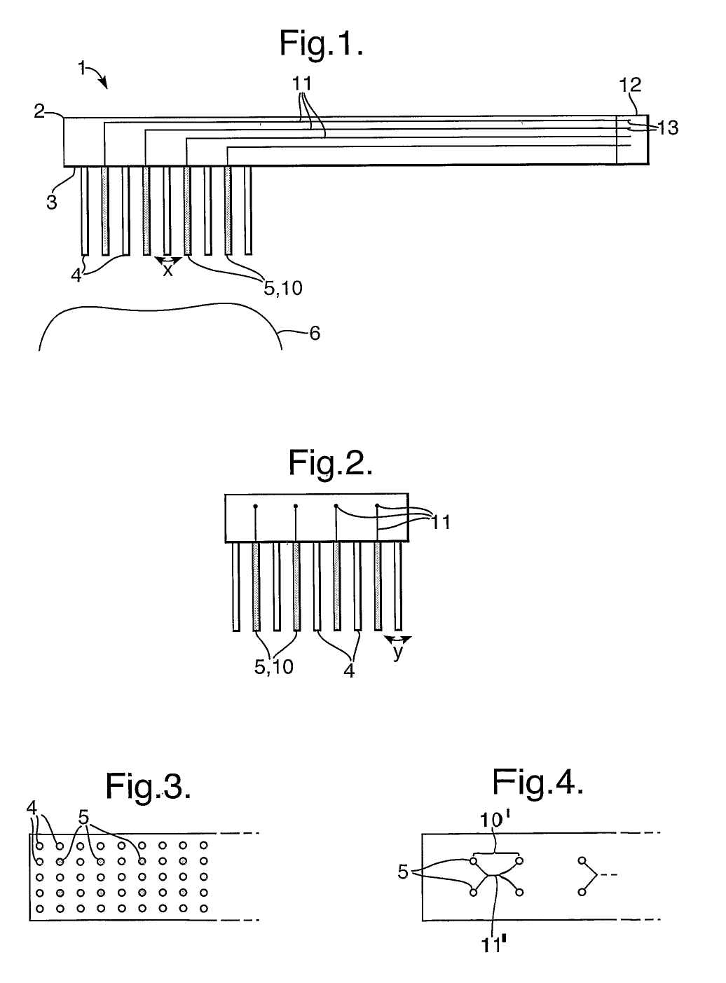

FIG. 1 is a side view of a first example electrode assembly;

FIG. 2 is a view of the first example from one end;

FIG. 3 shows the arrangement of the elements in the first example;

FIG. 4 shows the electrical connection of some of the elements in the first example;

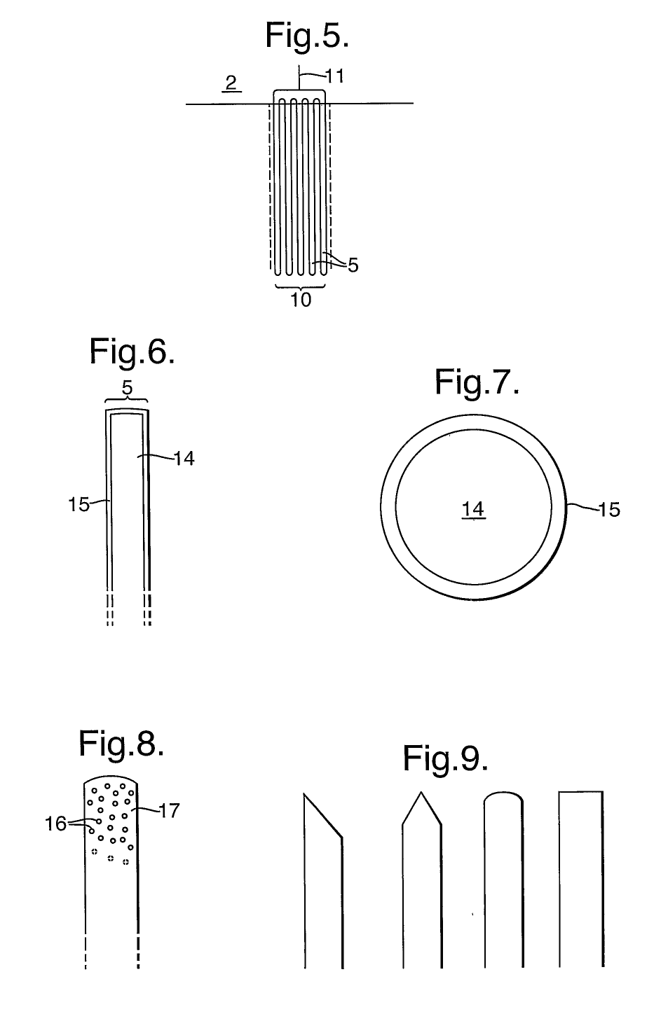

FIG. 5 shows the anchoring of connected elements in the first example;

FIG. 6 shows a section along the length of a coated element;

FIG. 7 shows a corresponding cross-section;

FIG. 8 shows electrically conductive particles in a conductive polymer element;

FIG. 9 illustrates configurations of the element ends for contacting the tooth;

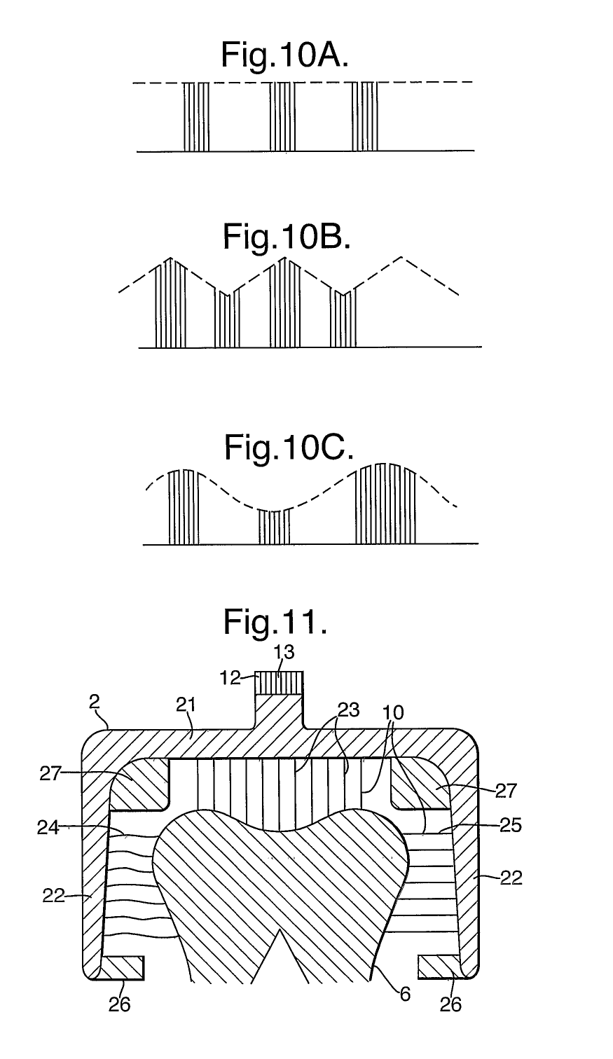

FIG. 10a shows groups of elements of the same length;

FIG. 10b shows elements having lengths according to a saw-tooth waveform;

FIG. 10c shows elements having lengths according to a sinusoidal waveform;

FIG. 11 shows an electrode assembly according to a second example;

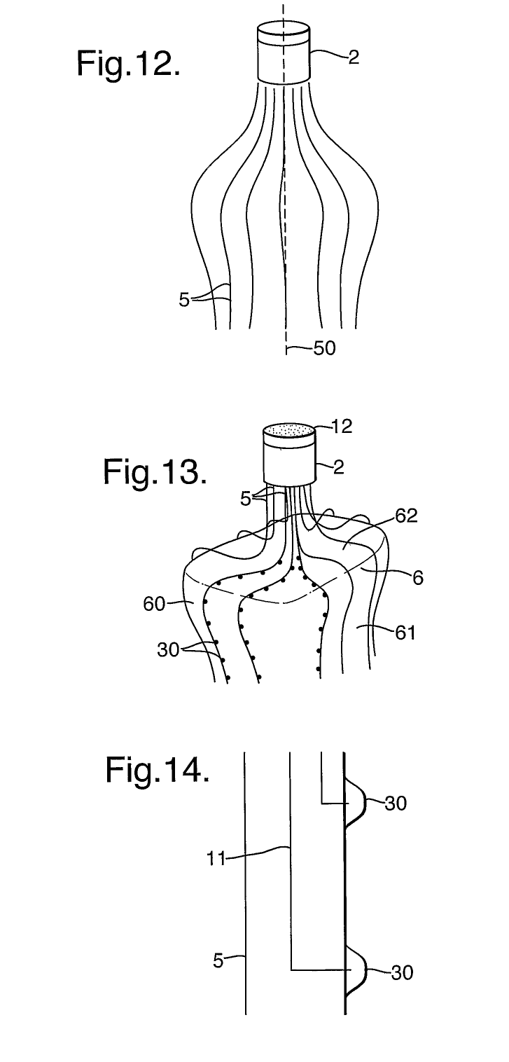

FIG. 12 shows an electrode assembly according to a third example;

FIG. 13 shows the third example assembly located upon a tooth;

FIG. 14 shows an electrode element of the third example in more detail;

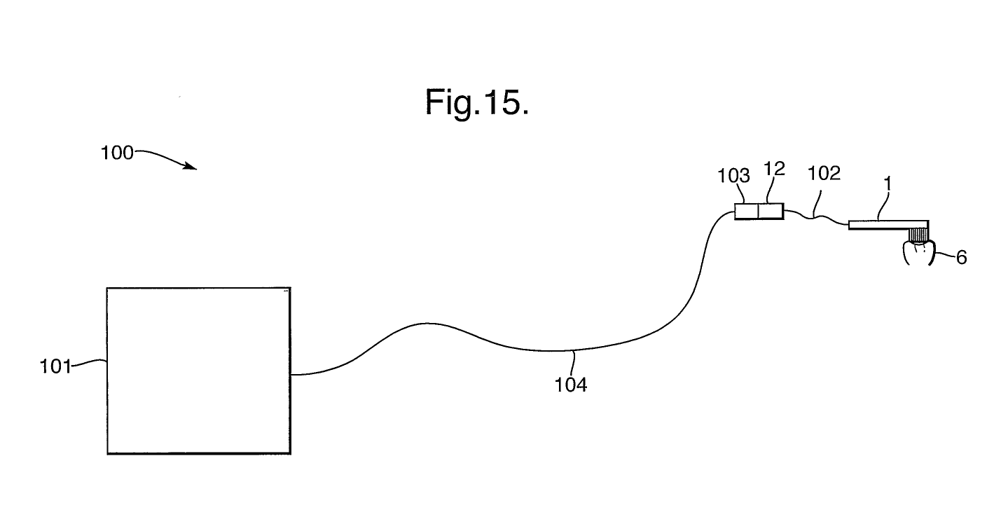

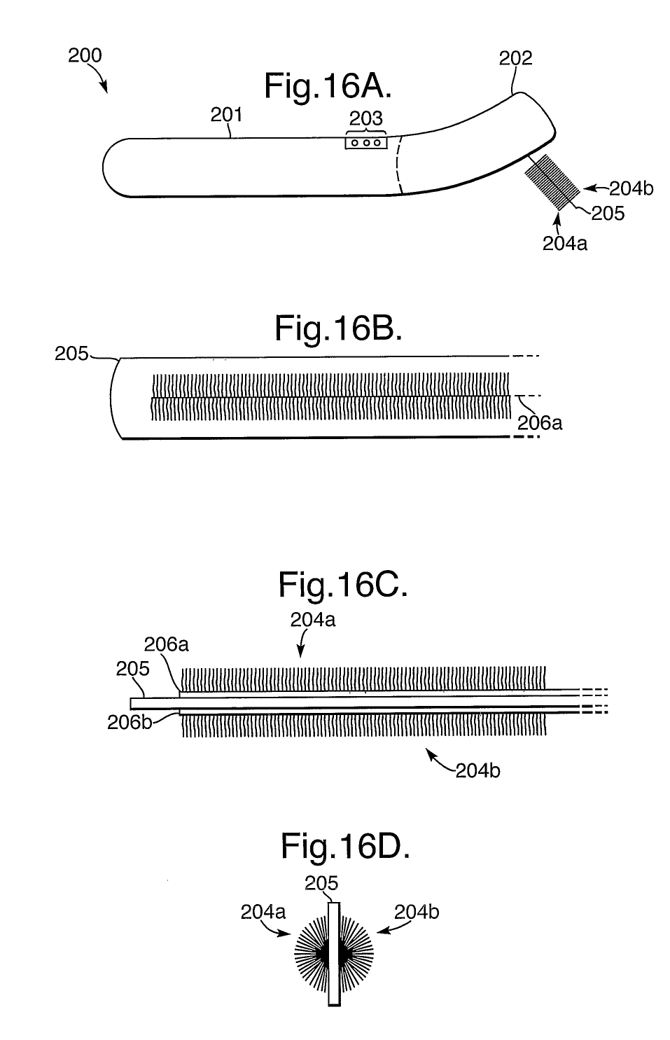

FIG. 15 is a schematic illustration of an example system using the electrode assemblies;

FIG. 16A shows an alternative example system;

FIG. 16B shows a fourth example assembly when viewed from one side;

FIG. 16C shows the fourth example assembly when viewed from above; and,

FIG. 16D shows the fourth example assembly when viewed from the end.

FIG. 1 is a side view of a first example electrode assembly according to the invention, this having the approximate appearance of a toothbrush. The assembly comprises a holder 2 formed from polyamide The holder 2 is elongate and from one surface of the holder towards one end, a series of elements project substantially perpendicularly from a lower surface 3 of the holder 2. Two types of elements are illustrated in FIG. 1, the first type being electrically insulating elements 4, and the second being electrically conductive elements 5. The elements 4 are formed from a suitable insulating material such as nylon. The electrically conductive elements 5 are also formed from nylon, although in this case they are coated with an electrically conductive layer of carbon. This coating is provided over the entire exposed surface. As illustrated, each conductive element 5 is spaced from the next adjacent conductive element by an intervening insulating element 4.

Referring to FIG. 2, which shows the assembly 1 when viewed from the end having the elements, it can be seen that a number of elements of both the conductive and insulating types are positioned into the plane of the figure of FIG. 1. Again, the conductive elements 5 are each separated from adjacent conductive elements 5 by insulating elements 4. The conductive elements therefore form an array of such elements, this being interleaved with a similar array of insulating elements 4.

The electrode assembly 1 in the first example is an “occlusal” electrode assembly in that it is adapted for applying electrical currents to an occlusal surface of a tooth. An upper part of a tooth 6 (including the occlusal surface) is illustrated schematically in FIG. 1.

Each of the projecting elements of the present example has a length of about 5 millimetres and a diameter of about 100 micrometres. The elements are substantially circular in cross-section although other geometrical shapes in cross-section are envisaged.

As is illustrated in FIGS. 1 and 2, since the elements are anchored at the holder 2, each with a distal free end, the free end may be deflected about the respective anchoring point as is shown by the arrows “x” and “y” in FIGS. 1 and 2. The ease of deflection is controlled by the stiffness of the material used, the length of the element and its cross-section.

Since the exposed surfaces of the conductive elements 5 are arranged to be electrically conducting, each conductive element 5 in the present example is an electrode 10. At the point where each of the elements 5 is anchored to the assembly 1 (for example by an adhesive or by melt bonding), the conductive coating is electrically connected to respective wires 11 which pass within the structure of the holder 2, to the other end of the holder 2 which is remote from the elements. The wires may be formed from copper. They may also run along the outer surface of the holder provided they are suitably insulated. At the distal end of the holder, a connector 12 is provided, this having a series of pins 13, each pin being connected to one of the wires 11. The connector may take any suitable form and be adapted to connect to a corresponding socket connector of a lead cable (not shown in FIG. 1). The lead cable is in turn connected to a system for providing the electrical current to the electrodes 10 via the connector 12 and wires 11 so as to perform the electrical impedance measurements.

In FIG. 1, each of the elements is illustrated as having approximately the same length. However, this is schematic since the occlusal surfaces of teeth typically comprise relatively deep fissures. In practice, the lengths of the elements are arranged so as to conform to the different levels of the occlusal surface as a function of position.

FIG. 3 shows an example arrangement when viewed along the elements, in this case as an example modification to the first example, there is a larger number of insulating elements 4 than conducting elements 5. Each conductive element is surrounded by eight insulating elements. In FIG. 4, an example is shown of how the arrangement of conducting elements in FIG. 3 can be connected together such that four of the conducting elements 5 are electrically connected by wiring 11′ so as to form a single electrode 10′ having four elements 5.

FIG. 5 shows an alternative arrangement in which a number of the projecting elements 5 are physically anchored together at their base or may even form a single component at their base anchor point within the holder 2. This is advantageous since only one of the elements 5 need contact the respective surface of the tooth so as to provide the required electrical connection.

FIG. 6 shows the structure of a conductive element 5 in more detail, the internal (nylon) material 14 forming the main structure of the element is coated in a thin layer of carbon illustrated at 15. The thickness of the carbon layer may be typically 100 nanometres to 100 micrometres in thickness. FIG. 7 shows the corresponding cross-section of the element 5. FIG. 8 shows an alternative structure of the element 5 in which a coating is not used. In this case, the conductivity is provided by conductive particles embedded in a polymer matrix. The conductive particles may be carbon, gold, copper, nickel or other metals (including solid “noble” metal particles or such metals coated on a core material). The conductive particles are indicated at 16 with the matrix material, such as any suitable plastic, being illustrated at 17. Alternatively a conductive matrix such as a conducting polymer matrix or metallic matrix (for example gold) could be used and therefore the need for conductive particles obviated.

FIG. 9 shows various alternative configurations for the ends of the elements, including two forms of sharpened end, a hemispherical or rounded end, and a flat end. These arrangements can be used for elements in which the ends provide the contact points of the electrodes, for example in the case of solid conductive elements or coated conductive elements.

Whilst the extreme ends of the elements may be made to adopt certain geometries, the respective lengths of the elements may similarly be adapted to adopt certain geometries as shown in FIG. 10a to 10c. In FIGS. 10a to 10c, the elements are each arranged in groups. In FIG. 10a the elements in each group are of the same length and lengths of the elements in different groups are also the same.

In FIG. 10b the lengths of the elements are in accordance with a saw-tooth waveform. Whereas in FIG. 10c, the element lengths are in accordance with a substantially of sinusoidal waveform. In each case, the elements need not necessarily be arranged in groups or, when they are arranged in groups, the number in each group may be different.

A second example electrode assembly is now described, this being adapted for providing simultaneous electrical contact of electrodes upon multiple surfaces of a tooth. This example is particularly suited for use with a premolar or molar tooth and is shown in FIG. 11. In this case, the holder 2 takes the general form of three connected sides of a rectangular prism. It therefore has three connected substantially planar parts, a first occlusal part 21 being designed to be located above the occlusal surface of a premolar or molar tooth. Two substantially planar parts 22 project from the occlusal part, these being smooth surface parts. The holder 2 as a whole is therefore designed to sit on the occlusal surface of the tooth 6 (in this case being a premolar). FIG. 11 shows the holder 2 according to the second example correctly located. As is illustrated, three groups of elements are provided, these being occlusal elements and inward-facing and outward-facing elements, the terms “inward” and “outward” referring to the mouth in which the tooth 6 is positioned. The occlusal elements are illustrated at 23 with the inward elements (inward towards the mouth centre) being shown at 24, and those facing away from the mouth centre (outward) being shown at 25. Each of the three sets of elements 23, 24, 25 is of a length which generally conforms with the shape of the tooth 6 (see FIG. 11). It should be noted also in FIG. 11 that the elements 23 and 25 are simply drawn as straight lines for illustration purposes only. In practice, contact by these elements with the tooth causes them to deflect in use and this is illustrated with the elements 24. Note that, as in the first example, the elements 23, 24 and 25 are in each case separated by insulating elements.

Each of the optional configurations in association with the first example, including groups of elements, and how they are electrically connected together, are also envisaged with respect to the second example shown in FIG. 11. In FIG. 11 an electrical connector 12 and pins 13 are also illustrated, although the wiring between these and the respective electrodes 10 is not shown but of course is present.

Along the lower edge of the parts 22 (closest to the gingiva), electrically insulating pads 26 are attached so as to prevent the ingress of saliva between the electrodes 10, and also to prevent electrical contact between the gingiva and the lowermost electrodes. The presence of a large amount of saliva is undesirable since it provides a low impedance path between the electrodes. Similarly insulating pads 27 are provided between the sets of elements of the parts 21 and 22, so as to separate the elements from the surface 21 from coming into contact with those on the surfaces 22.

With reference to FIG. 11, it will be appreciated that the assembly, and in particular the parts 21, 22, 26 and 27 all extend into the plane of the figure, with more elements being provided in this third dimension.

Whilst this second example is adapted for measurements of the occlusal and opposed free smooth surfaces, a modified example is envisaged in which further electrodes are provided for taking measurements upon the approximal surfaces. Since there is normally either contact or a close approach of, adjacent teeth along the approximal surfaces, such a modified embodiment may advantageously be provided with two parts (for each approximal surface) extending downwardly from the part 21 of FIG. 11 (parallel to the plane of the figure), one part being positioned to the inward side of the mouth, and the other to the outward side of the mouth with a gap between them.

It will be understood that, with use of plastics materials for the holder 2, a degree of resilience and flexibility is provided by the holder such that the assembly may be positioned over the desired tooth. The spacing of the elements, together with their length and resilience is adjusted according to the application.

A third example is now described which is capable of providing measurements upon all five surfaces of a tooth. This is illustrated in FIGS. 12 to 14. In this case, the elements 5 again project away from a holder 2. However, each element 5 is of a specialised resilient form. Each element 5 initially projects from the holder 2 in a first direction, curves outwardly (away from a central axis passing through the holder 2) and then inwardly once more to terminate once again in approximately the first direction. Each of the elements 5 can therefore be thought of as taking a similar form, each having a form curving outwardly and then inwardly again with respect to a central axis. The elements 5 are arranged symmetrically about this axis. This is shown in FIG. 12, with the central axis being indicated at 50.

FIG. 13 shows the assembly of the third example positioned upon a molar tooth 6, this being illustrated schematically. In order to fit onto the tooth the elements 5 are deflected such that the tooth can be accommodated between the elements. When in use, the elements are biassed, due to their resilience, against the tooth surfaces, particularly the approximal 60 and free smooth surfaces 61. It will be noted that each of the elements 5 is this time provided with a number of contact electrodes 30, some nearer the holder being positioned, due to the deflection of the elements 5, in contact with the occlusal surface 62. Each of the contact electrodes 30 is individually wired to the connector 12 attached to the holder 2. The number of contact electrodes 30 upon each element 5 may be selected according to the application in question.

The individual contact electrodes 30 may be formed from a suitable spot of metallic material with individual wires 11 being provided in the element 5. This is shown in FIG. 14. The connections by wires 11 inside the elements 5 may be provided by copper wires or tracks in an insulating polymeric matrix. Alternatively, individual insulated wires may be used, these being bundled together in a tube so as to form the element 5. These may be anchored additionally to a core element providing some or all of the resilience. A metal with an insulated coating can be used having a suitable modulus of elasticity to provide the required level of resilience without yielding. A spring steel or shape memory alloy could be used for this purpose. In an alternative form of this example, with fewer electrodes, each of the elements may be formed from stainless steel and each may comprise a single electrode.

In each of the embodiments described the connector 12 has been positioned adjacent the holder 2. However, in some cases it may be beneficial to provide a short length of electrical wire to separate the connector 12 from the holder 2 such that a reliable connection with an external lead of monitoring apparatus can be provided. This can therefore be kept clear of the animal or human mouth in which the electrode assembly is positioned.

The electrode assembly in each case is used in conjunction with a system for applying electrical currents to teeth and monitoring the performance of the localised circuits formed. A schematic representation of such a system 100 is shown in FIG. 15. Here a monitoring device 101 provides electrical currents to parts of the tooth 6 using an electrode assembly 1 such as any assembly described earlier. In this case the connector 12 is spaced from the holder 2 by a short length of wire 102. This is connected electrically to a corresponding connector 103 of a lead 104. The lead 104 contains a number of wires to allow circuits to be formed using the electrodes of the elements 5 of assembly 1, and is connected to the monitoring device 101. The device 101 may be a self-contained unit for monitoring and also processing the electrical response of the circuits formed using the electrodes. It may also represent a system comprising a number of units including for example a computer for processing the data. In addition, each of the components shown in FIG. 15 may be formed within a single unit which is held in one hand by a dentist. This might be the case in a device where a visual indication is given to the dentist regarding the condition of the particular tooth or teeth in question, this being provided for example audibly or via a “traffic lights” series of LEDs.

FIG. 16A shows an alternative monitoring system, this being hand-held (in a single hand) rather like a pen. All of the elements within the system 100 of FIG. 15 are contained within the single unit 200. An elongate hand-held part 201 contains a power supply, signal generator, microprocessor and associated electronics so as to provide electrical signals to a plurality of electrodes within a detachable head portion 202. The unit could be provided with rechargeable batteries and adapted so as to fit in a charging cradle.

A display is provided at 203 in the form of red, orange and green LEDs which indicate the condition of the tooth being monitored, green representing a healthy tooth for example. The head portion 202 is detachable from the hand-held unit part and in this case contains electrodes for monitoring two adjacent teeth. The part of the head portion containing the electrodes is angled with respect to the elongation axis of the hand-held portion 201. The head portion 202 forms part of a fourth example assembly of the invention.

The electrodes 5 in this case are provided in the form of two opposed conducting “brushes”. These are indicated at 204a and 204b respectively. The elements of the brushes in this example are formed from stainless steel coated carbon-loaded plastic so as to provide a very low impedance. Each brush electrode 204a, 204b is in the form of half of a “bottle brush” that is, a half of a cylindrical brush in which bristles project from a central region in a radial manner and a large number of such brushes project radially along the axis of the cylinder. The cylinder is divided in half along its axis so the brushes of each electrode 204a, 204b can be thought of as projecting radially through up to 180 degrees of angle about the cylinder axis.

The electrode brushes 204a and 204b are electrically insulated from each other by a central insulating barrier 205. The barrier 205 may take the form of a plastic plate or strip. In the present case the barrier is rectangular in design with a thickness of 80 to 100 micrometres, a height of about 2 millimetres and a length of about 10 millimetres. The upper and lower edges are preferably bevelled (at an angle of typically 60 degrees).

The assembly is shown in more detail in FIGS. 16B and C. FIG. 16B shows the barrier 205 and one of the brush electrodes, in this case the electrode 204a. Each of the bristles of the brush 204a project from an elongate wire 206a which is mounted to the barrier 205. A similar electrode wire 206b is provided upon the other side of the barrier for the electrode 204b. The wires pass into the plastic head 202 and are coupled electrically to the signal generator and so on, via connectors in the head 202 and hand-held portion 301. In FIG. 16A, it should be noted that the bristles project at various angles out of the plane of the figure.

The electrode wires have a diameter of about 0.3 millimetres. The brush electrode elements are about 0.6 to 0.8 millimetres in length with a thickness of about 0.1 to 0.2 millimetres.

As will be appreciated, a large number of bristles are provided for the electrode brushes, each of these are electrically conducting and may take the form of the various electrodes discussed earlier. In the present example there are up to 20 rows of bristles, the rows being spaced apart by a gap of about 0.5 millimetres. The distal end of the barrier extends beyond the end of the bristles by about 1 millimetre.

The bristles together act effectively as a common electrode such that all bristles have an equal electrical potential for the electrode 204a. Similarly, all points upon the electrode 204b also have an equal electrical potential although the electrodes 204a and 204b are electrically isolated from each other so that they may be used to perform measurements upon adjacent teeth. FIG. 16D is a view looking along the axis of the electrodes and here is can be seen that the bristles of the electrode 204a and 204b do indeed project through substantially 180 degrees of angle each, about the elongate axis of the electrode as a whole.

The two electrodes 204a and 204b can be operated independently of one another using a switch placed upon the assembly body. A trigger switch is also provided so that an operator can initiate the electrical impedance measurement in question.

By way of further explanation, the barrier (which can be thought of as a separating strip), is aligned approximately orthogonally to the elongation axis of the hand-held portion 201 in each of the “horizontal” and “vertical” planes. When the hand-held portion 201 is held such that the display 203 faces the buccal part of the mouth (away from the teeth), the electrodes are inserted into the interproximal space between the two teeth whose impedance it is desired to measure. The electrodes are pushed lingually into the contact area and thereafter in an occlusal direction until firmly positioned. The mesial of the two brush electrodes contacts the distal surface of one of the two approximating teeth and the distal of the brush electrodes contacts the mesial surface of the other approximating tooth. The assembly of this fourth example allows the bristles to deform and conform to the three-dimensional curvature of the approximating surfaces of the teeth. This facilitates the electrical measurement of each of the two surfaces to be performed independently, with no short-circuit between the two brush electrodes.

When in use therefore, this electrode assembly is suitable for performing separate measurements upon opposed surfaces of adjacent teeth. In particular, it is suitable for performing measurements upon the approximal surfaces, particularly adjacent the gingiva, although it could also be used for the parts of the approximal surfaces which border the respective occlusal surfaces of the adjacent teeth. The arrangement shown in FIGS. 16A to 16D has a high degree of symmetry which allows this assembly to be used in all four quadrants of the mouth of a patient (upper and lower and left and right parts of the mouth).

The system shown in FIG. 16A is advantageous in that it is simple to use and the detachable nature of the head 202 allows various different electrode arrangements to be used with a single common part 201 (containing the electronics). Various teeth may therefore be investigated by electrical impedance measurements using interchangeable heads 202 and different heads may be provided for adults and children.

This system is described only in a schematic and general manner since the electrode assembly may be used in association with many different systems. The electrode assembly can be used to implement many forms of electrical caries detection, including AC Impedance Spectroscopy and Electrical Impedance Tomography amongst others. These systems are riot limited to the monitoring of human teeth and are intended to include systems for monitoring animal teeth. In either case this may be in vitro or in vivo, with the in vivo application of course providing many benefits relating to dental health.

1. An electrode assembly for passing electrical current through at least part of a tooth, the assembly comprising:
an electrode holder; and
a plurality of resilient projecting elements coupled to the holder, each element comprising one or more electrodes, the assembly being arranged in use such that when the assembly is positioned adjacent a tooth, the electrodes contact respective parts of at least one surface of the tooth.

2. An electrode assembly according to claim 1, wherein a number of the electrodes in different elements are connected together electrically.

3. An electrode assembly according to claim 1, further comprising one or more electrically insulating resilient elements positioned between the elements having the electrodes.

4. An electrode assembly according to claim 1, wherein, when in use, the assembly is adapted such that the resilience of the elements biasses the electrodes against the at least one surface of the tooth.

5. An electrode assembly according to claim 1, wherein the elements project from the holder in substantially at least one direction.

6. An electrode assembly according to claim 4, wherein the holder is adapted such that the elements project from the holder in substantially two, three, four or five directions.

7. An electrode assembly according to claim 6, wherein each projection direction is in the direction of a respective tooth surface.

8. An electrode assembly according to claim 1, wherein one or more of the elements have different relative lengths.

9. An electrode assembly according to claim 8, wherein the relative lengths are adapted so as to conform generally with the shape of the respective tooth surface they are intended to contact in use.

10. An electrode assembly according to claim 1, wherein each element having the electrodes, has two or more electrodes spaced upon its length for contacting the tooth at different locations upon the respective surface.

11. An electrode assembly according to claim 10, wherein each electrode is arranged such that the part of the electrode that contacts the tooth is substantially a point contact.

12. An electrode assembly according to claim 1, wherein each element that comprises the one or more electrodes is formed from an electrically conductive material such that the element is an electrode.

13. An electrode assembly according to claim 12, wherein the material is a conductive polymer.

14. An electrode assembly according to claim 12, wherein each element comprising the one or more electrodes is formed from a material coated with an electrically conductive coating such that the element is an electrode.

15. An electrode assembly according to claim 14, wherein the coating is formed from gold, a gold alloy, carbon, stainless steel, titanium, multi-layers of these materials or a conductive paint.

16. An electrode assembly according to claim 14, wherein the material that is coated is nylon.

17. An electrode assembly according to claim 12, wherein the electrically conductive material is stainless steel.

18. An electrode assembly according to claim 1 wherein an electrical connection to each element having the electrodes is provided using a respective conductive wire or track.

19. An electrode assembly according to claim 1, wherein the length of the elements lies in the range 0.5 millimetres to 10 millimetres.

20. An electrode assembly according to claim 1 wherein the thickness of the elements is in the range 50 to 500 micrometres.

21. An electrode assembly according to claim 1, further comprising a connector having contacts arranged in electrical communication with the electrodes, the connector being adapted to detachably couple electrically to a corresponding connector of a monitoring system.

22. An electrode assembly according to claim 1 wherein the holder is formed having an elongate handle such that the holder may be grasped in use by a user so as to hold the electrodes in position in contact with the tooth.

23. An electrode assembly according to claim 1, wherein the holder is formed from an electrically insulating material.

24. An electrode assembly according to claim 1, wherein the assembly is adapted as a single-use disposable assembly.

25. An electrode assembly according to claim 1, further comprising one or more pads positioned to reduce or prevent contact between the gingiva with an electrode and/or the ingress of saliva between the electrodes.

26. An assembly according to claim 1, wherein a number of the elements comprising the electrodes are separated from each other by one or more electrically insulating barriers which project from the holder.

27. An assembly according to claim 26, wherein the barrier is a strip or plate.

28. An assembly according to claim 26 wherein first and second sets of elements project in a mutually opposed direction from a central electrically insulating barrier, such that the first and second sets are electrically insulated from each other, the assembly being arranged such that, when in use, the first and second sets contact respective first and second teeth.

29. An assembly according to claim 28, wherein each element of the sets is an electrically conducting bristle, the bristles of each set each being connected electrically to all other elements in the respective set.

30. An assembly according to claim 28, wherein the barrier is a substantially planar plate or strip.

31. An assembly according to claim 28, wherein each set of elements is connected to a corresponding wire which runs along one side of the barrier.

32. A system for monitoring the structure of a tooth comprising:
an electrode assembly for passing electrical current through at least part of a tooth, the assembly comprising:
an electrode holder; and
a plurality of resilient projecting elements coupled to the holder, each element comprising one or more electrodes, the assembly being arranged in use such that when the assembly is positioned adjacent a tooth, the electrodes contact respective parts of at least one surface of the tooth; and
a monitoring device adapted in use to pass an electrical current through at least one electrode of the assembly and at least a corresponding part of the tooth, and to monitor the electrical response of the circuit.

33. A system according to claim 32, wherein the electrode and monitoring device comprise a unit which may be held in one hand.

34. Use of an electrode assembly according to claim 1 to pass electric current through at least part of a tooth in which the assembly is positioned adjacent to a tooth and the electrodes are contacted with respective parts of at least one surface of the tooth, an electric current is passed through the electrodes and the tooth, and the electrical response of the circuit is monitored.
